(19) United States
(12) Patent Application Publication
(10) Pub. No.: US 2005/0110634 A1
(43) Pub. Date: May 26, 2005

(54) Portable security platform

(76) Inventors: David M. Salcedo, Lake Worth, FL (US); Douglas A. Narlow, Coral Springs, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 10/718,447

(22) Filed: Nov. 20, 2003

(51) Int. Cl. G08B 1/08

(52) U.S. Cl. 340/539.1; 348/152

(57) ABSTRACT

A security system including a camera configured to generate a video signal, an object recognition system coupled to the camera and configured to receive and monitor the video signal and a portable personal digital assistant (PDA) wirelessly coupled to the object recognition system and the camera. The PDA may display video from the camera and/or data or alarms in response to output from the object recognition system. Methods of providing security information including displaying live video on a PDA and providing a signal on the PDA in response to an output of an object recognition system are also provided.

### FIELD OF THE INVENTION

The present invention relates to security systems and, in particular, to a security system including a portable component for accessing security data.

### BACKGROUND

In known security systems, a variety of security data may be communicated to a central surveillance location from various security devices. Security personnel who desire access to such security data must access the data from the central location. This inhibits their ability to investigate incidents in person and to be timely notified of various occurrences. For example, security personnel who wish to view live or recorded video from a security camera must do so at the central surveillance location.

Accordingly, there is a need for a security system having a portable component enabling a user to efficiently receive and evaluate security information from various systems of a security network.

### SUMMARY OF THE INVENTION

According to one aspect of the invention there is provided a security system including: a camera configured to generate a video signal; an object recognition system coupled to the camera and configured to receive the video signal; and a portable personal digital assistant (PDA) wirelessly coupled to the object recognition system and the camera. The PDA may display video from the camera and/or data or alarms in response to output from the object recognition system.

According to another aspect of the invention, there is provided a method of providing security information. The method includes: generating live video of a surveillance area; communicating the live video via a wireless connection to a portable personal digital assistant (PDA); and displaying the live video on the PDA. According to yet another aspect of the invention there is provided a method of providing security information including: operating a camera to capture an image of an object; comparing data representative of the object with stored data; and providing a signal to a portable digital assistant (PDA) in response to the comparing step.

### BRIEF DESCRIPTION OF THE DRAWINGS

For a better understanding of the present invention, together with other objects, features and advantages, reference should be made to the following detailed description which should be read in conjunction with the following figures wherein like numerals represent like parts:

FIG. 1 is block diagram of an exemplary security system consistent with the invention having a portable personal digital assistant (PDA) wirelessly connected to a network having a video recorder and an object recognition system;

FIG. 2 is a block diagram of the PDA of FIG. 1;

FIG. 3 is a plan view of the PDA of FIG. 1 illustrating exemplary control, data, and video areas of an exemplary output video screen of the PDA;

FIGS. 4A and 4B are flow charts of exemplary methods of operation of the PDA of FIG. 1;

FIG. 5 is a flow chart of an exemplary method of operation of the object recognition system of FIG. 1; and

FIG. 6 is a flow chart of an exemplary method of operation of the video recorder of FIG. 1.

### DETAILED DESCRIPTION

For simplicity and ease of explanation, the present invention will be described herein in connection with various exemplary embodiments thereof. Those skilled in the art will recognize, however, that the features and advantages of the present invention may be implemented in a variety of configurations. It is to be understood, therefore, that the embodiments described herein are presented by way of illustration, not of limitation.

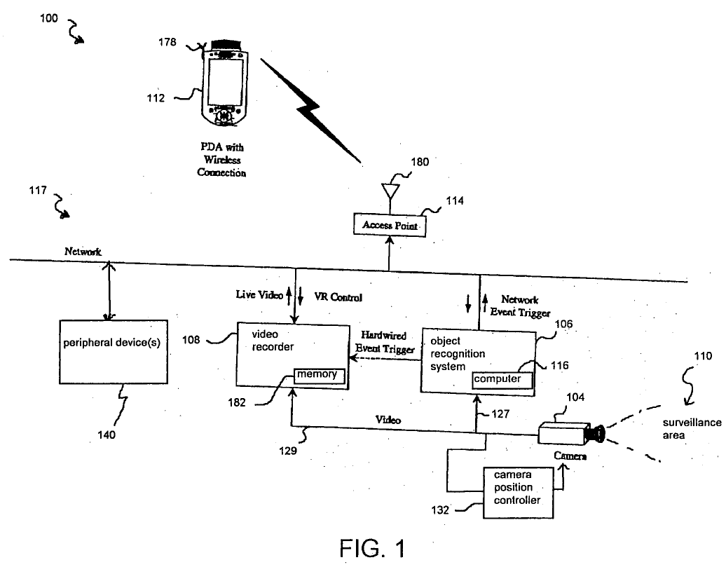

FIG. 1 is a block diagram of an exemplary security system 100 consistent with the invention. In general, the security system 100 may include a portable personal digital assistant (PDA) 112 wirelessly connected to a network 117 through an access point 114. The network 117 may include a variety of components and systems including, but not limited to, a camera 104, an object recognition system 106, a video recorder 108, and other peripheral devices 140, e.g. an access control system, metal detector, alarms, etc., that communicate with the PDA 112 as further detailed herein. Those skilled in the art will recognize that the portable PDA 112 may be wirelessly connected to the network 117 in a variety of ways, e.g., through communication of electromagnetic signals between antennas, by an infra red link, etc. In one embodiment, an antenna 178 on the PDA 112 may transmit and receive data from the antenna 180 of access point 114 functioning as a wireless transceiver.

The camera 104 takes video of a surveillance area 110. The surveillance area 110 may be an exit/entrance of a retail store, an area around a cash register, an area around a protected asset, etc. The camera 104 may be oriented in a fixed direction or a camera position controller 132 may be coupled to the camera 104 for adjusting the pan-tilt-zoom of the camera and/or to position the camera at various viewing angles. The camera position controller 132 may also be responsive to control signals from the PDA 112 so a user of the PDA can adjust the pan-tilt-zoom of the camera 104 as desired. The live video from the camera 104 may be communicated via path 127 to the object recognition system and via path 129 to the video recorder 108. Those skilled in the art will appreciate that the live video from the camera 104 may be communicated to the object recognition system 106 and video recorder 108 in a variety of ways, e.g., through network cables or a wireless connection.

The object recognition system 106 is configured to recognize any variety of objects entering the surveillance area 110. In general, the object recognition system 106 may receive live video from the camera 104 and analyze the video to detect if an object has entered the surveillance area 110. The object recognition system may compare data representative of the detected object with data representative of a plurality of known objects to ascertain if an acceptable correlation exists. Those skilled in the art will recognize that the object recognition system 106 may include a computer 116 provided in a variety of known configurations to analyze the live video from the camera 104.

The video recorder 108 may be any of a variety of known video recorders such as a digital video recorder. The video recorder 108 may also have internal memory 182 for storing a recorded video segment of the live video from the camera 104 as further detailed herein.

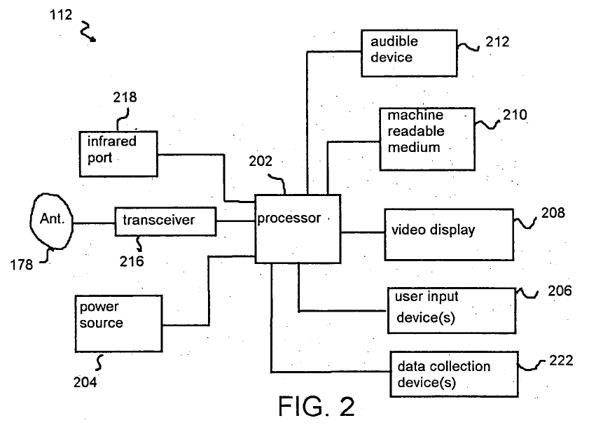

In the illustrated exemplary embodiment, the PDA 112 is a portable hand-held computing device having a variety of known components. FIG. 2 is a block diagram of an exemplary portable PDA 112 consistent with the invention. In general, the PDA 112 may include a processor 202, a power source 204 (e.g., a rechargeable battery), user input devices 206 (e.g., user input buttons, a keyboard, a touch screen, etc.), a video display screen 208 (e.g., LCD display which typically also includes a touch screen), machine readable media 210, an audio device 212, and data collection devices 222 (e.g. bar code scanner, digital camera, proximity card detector, etc.).

The processor 202 may be any type of processor capable of providing the speed and functionality required by the embodiments of the invention. For example, the processor 202 may be a processor from the Pentium® family of processors made by Intel Corporation, or the family of processors made by Motorola. Machine-readable media 210 includes any media capable of storing instructions adapted to be executed by a processor. Some examples of such media include, but are not limited to, read-only memory (ROM), random-access memory (RAM), programmable ROM (PROM), erasable programmable ROM (EPROM), electronically erasable programmable ROM (EEPROM), dynamic RAM (DRAM), and any other device that can store digital information. The instructions may be stored on the medium in a compressed and/or encrypted format.

The PDA 112 is equipped for wireless communication with other components of the network 117. Such wireless communication may take place in a variety of ways known to those skilled in the art. For instance, such communication may take place through communication of electromagnetic signals between antennas. In this instance, the PDA 112 may have an antenna 178 and transceiver 216. The PDA may also have an infrared port 218 for communication via an infra red link.

Advantageously, the PDA 112 is configured for bi-directional communication over a wireless interface with the network 117. In one exemplary mode of operation, live video of a surveillance area 110 is provided to the computer 116 of the object recognition system 106. The computer 116 analyzes the live video to detect if an object, e.g. a person, has entered the surveillance area 110. If an object is detected, the object recognition system 106 provides a detection signal. In response to the detection signal, the video recorder 108 may begin recording live video from the camera for a predetermined time interval to create a recorded video segment.

The computer 116 may compare a digital representation of the detected object, e.g. a digital representation of a person's face, with a plurality of stored digital representations of identified or known objects. A database of identified or known objects may be stored in a memory accessible through the network, e.g. in a memory local to the object recognition system. If a proper correlation is made between the detected object and the stored object, the object recognition system 106 may provide an identification signal to the video recorder 108 and to the PDA 112.

In response to the identification signal, the PDA 112 may provide an alarm signal, e.g., via the audio device 212 and/or video display 208, to alert a user of the PDA 112 that the object recognition system has identified an object. Also, the video recorder 108 may save the recorded video segment, e.g., in a memory 182 of the video recorder. Otherwise, the video recorder 108 may delete the recorded video segment if the object recognition system did not correlate the detected object with a stored object. In addition, a user of the PDA 112 may utilize various user input devices 206 to provide a command signal to the video recorder 108 for retrieval of the recorded video segment.

For instance, when the object recognition system 106 is a facial recognition system, the system 106 may establish a digital representation of one or more faces identified from the live video provided by the camera 104. Such a digital representation of the detected person's face may be developed in a variety of ways known in the art, e.g. by analyzing various points and distances on a person's facial features such as the distance between eyes, width of nose, etc. The computer 116 may compare the digital representation of the detected face with various digital representations from known persons stored in a database of the computer 116. If an acceptable correlation between the detected facial image and a stored facial image is made by the computer 116, the facial recognition system may then notify the video recorder 108 and the PDA 112. The facial recognition system may then provide data associated with the detected person to the PDA 112, e.g., an image file of that person and/or various other data related to the detected person.

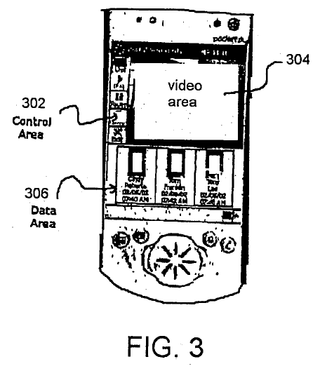

A security person using the PDA 112 may provide a command signal to the video recorder 108 using any variety of input devices 206 such as via input buttons or a control area 302 (FIG. 3) of a touch screen portion of the PDA 112, etc. In response, the video recorder 108 may provide the recorded video segment for that particular object, e.g., for a particular person. Such recorded video segment may be played back in the video area 304 of the video display screen of the PDA 112.

The security person may thus have efficient access to data on the object entering the surveillance area via the PDA. In addition, the security person may review live video on the PDA of the surveillance area and/or a recorded video segment of the object as it entered the surveillance area. Data related to a known object, e.g., an image file of a known person and/or other pertinent data related to the person, may be provided by the object recognition system 106 to the PDA 112 and displayed in a data portion 306 of the display screen. This enables the security person to have information efficiently available for determining a course of action, e.g., taking added precautions with a potential threatening person, making special accommodations for a particular person, etc.

Those skilled in the art will recognize that a variety of peripheral devices 140 may be coupled on the network 117 for wireless communication with the PDA 112. For instance, the peripheral device 140 may include an access control system. The camera 104 may be directed to an entrance outside a secure area. The access control system may automatically permit entrance to the secure area once an object has been recognized by the object recognition system. The PDA may be notified by the object recognition system if an authorized object entered the secure area and may also be notified if an unauthorized object attempted entry to the secure area. The PDA may notify the user of the PDA with associated alarm signals in such instances.

When the object recognition system is a facial recognition system, such an access control system may be used to identify authorized persons. If an authorized person is identified, an actuator of the system may be triggered to unlock a secured entrance thus allowing access to the authorized person. In addition, a signal may be sent to the PDA to notify the user of the PDA of the identity of a particular person who entered the secure area. If the facial image is not recognized by the facial recognition system or recognized as being associated with unauthorized personnel, access to the secured area may be denied by maintaining the secured entrance in a locked position. The PDA may then notify the user with a distinctive alarm signal in such an instance. The video recorder may also be configured to save recorded video segments of any failed attempts to enter the secure area. The user of the PDA can then also review the recorded video segment of the failed attempt to enter the secure area to decide what, if any, action is required.

Another peripheral device 140 that may be coupled to the network 117 is a metal detector. The metal detector may monitor access to a secure area for any persons carrying concealed metal, e.g., a concealed metal weapon. If the metal detector is activated, an alarm may be activated. In this instance, a signal may also be provided to the PDA indicating the metal detector alarm has been triggered. In addition, a detection signal may be sent to the video recorder indicating a person is about to enter the metal detector. In response, the video recorder may begin to record the live video from the camera. If the metal detector is not triggered, the recorded video segment or some portion thereof may be erased or discarded. If the metal detector is triggered, the recorded video segment may be saved. As such, a user of the PDA may instruct the video recorder to provide the recorded video segment associated with a particular metal detection so that the user can review how the subject was acting before and during the metal detection.

Yet other peripheral devices 140 that may be coupled to the network 117 include any variety of building sensors such as burglar alarms, fire alarms, smoke detectors, etc. These devices may provide a user of the PDA with an immediate indication of a potentially dangerous situation.

The PDA 112 may also be equipped with a variety of data collection devices 222 for supporting additional functionality. The data collection device 222 may include, for example, a handheld portable bar code scanner. The bar code scanner may be provided in a variety of known configurations such a pen-type, CCD, laser or camera based systems. A user may use the combined PDA/bar code scanner to track people and merchandise. A user may use the combined portable PDA/bar code scanner to scan a bar code on an item and transmit a signal representative of the bar code to a processor on the network 117. In response to the transmitted signal, asset information related to the scanned item may be accessed, e.g., from a database, and such asset information may be transmitted back to the combined portable PDA/bar code scanner.

In another example, the data collection device 222 may include a known proximity card detector. The proximity card detector may be used for validating security badges. In addition, the data collection device 222 may include a small digital camera for capturing an image of an object, e.g. of a person. The captured image may be sent by the PDA to the object recognition system, for acquiring data related to the person, e.g. to confirm that the person is authorized to be in the area.

In addition, if the object recognition system is facial recognition system, known persons can be grouped in various categories. For instance, persons may be grouped into desirable and undesirable categories. If a recognized person is a desirable person, a user of the PDA would be notified as such. In this instance, special accommodations may then be made for this desirable person. In contrast, if a recognized person is an undesirable person, the user of the PDA would be notified as such. The user may then review the actions of the person by reviewing the recorded video segment of such person. Appropriate action may then be taken by security personnel in such instances depending on the identity of the person and their actions.

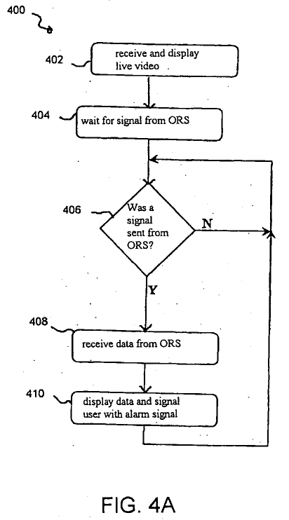

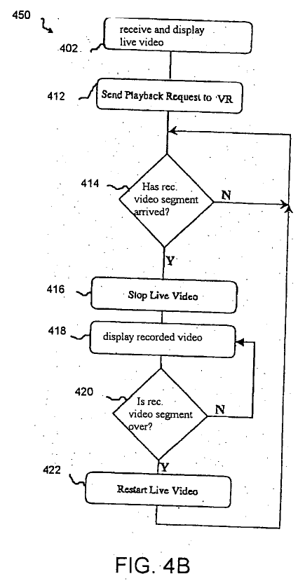

Turning now to FIG. 4A, a flow chart 400 of an exemplary method of operation of a PDA 112 consistent with the invention is illustrated. The flow charts used herein to describe various embodiments include particular sequences of steps. It can be appreciated, however, that the sequence of steps merely provides an example of how the general functionality described herein may be implemented. Further, each sequence of steps does not have to be executed in the order presented unless otherwise indicated.

In step 402, the PDA 112 receives and displays live video taken by the camera 104. Such live video may be displayed in the video area 304 of the video display of the PDA 112. While displaying live video, the PDA waits for an identification signal from the object recognition system (ORS) in step 404 indicating that an object that entered the surveillance area 110 was recognized or identified as being sufficiently correlated with a known object. If such an identification signal is not sent from the object recognition system in step 406, the PDA continues to display live video and waits for such an identification signal from the object recognition system.

If an identification signal is received from the object recognition system indicating a recognized object, the PDA then receives data associated with the known object and such data may be displayed in the data area 306 of the video display. For instance, when the object recognition system is a facial recognition system the data may include an image file of the known person's face. An alarm signal may also be provided by the PDA in response to the identification signal from the object recognition system to signal the user of the PDA that a known object has been recognized. The alarm signal may be output in a variety of ways known in the art including an audible alarm output the audio device 212, a visual alarm output the video display screen 208, or a motion alarm (e.g., vibration of a portion of the PDA), etc. The operation of the PDA may then cycle back and wait for another identification signal.

FIG. 4B is a flow chart 450 illustrating another exemplary method of operation of the PDA 112. In step 402, the PDA 112 receives and displays live video taken by the camera 104. The PDA may send a playback request to the video recorder 108 in step 412 as prompted by a user of the PDA, e.g., by utilizing the control area 302 of the video screen. The video recorder 108 then retrieves the appropriate playback video segment and provides it to the PDA 112. If the playback video segment has arrived, the PDA may then stop playing live video 416 and instead display the playback video 418 in the video area 304 of the display screen. If the playback video stream is finished 420 then live video may be displayed 422 and the PDA waits for another playback request. Alternatively, the video area 304 of the display screen may be parsed into two separate areas enabling both viewing of live video and playback video. As such, the starting and stopping of live video would not be necessary.

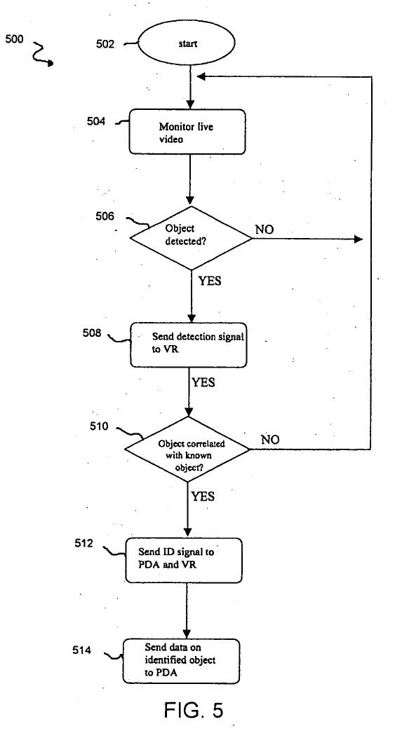

Turning to FIG. 5, a flow chart 500 illustrating operation of an exemplary object recognition system 106 is illustrated. The object recognition system monitors live video in step 504. If an object is detected, the object recognition system sends a detection signal to the video recorder in step 508. The detection signal may be sent in a variety of ways over any of a variety of a transmission media. Such transmission media may include a hardwire connection 152 between the object recognition system 106 and the video recorder 108 or a wireless network connection between the systems. If an object is not detected, the system continues to monitor the live video.

Once an object has been detected, the system compares data representative of the detected object with stored data representative of known objects. If the detected object is not correlated with known objects in step 510, the object recognition system continues to monitor the live video. If the detected object is correlated with a known object, the object recognition system sends an identification signal to the PDA 112 and the video recorder 108 in step 512. In addition, the object recognition system may send data, e.g., an image file of a person's face when the object recognition system is a facial recognition system, related to the identified object to the PDA 112.

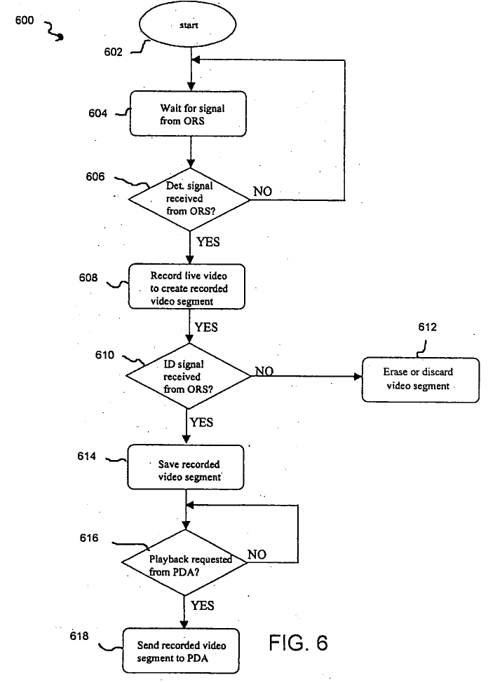

Turning to FIG. 6, a flow chart 600 illustrating an exemplary operating method of the video recorder 108 is illustrated. As the process starts in step 602, the video recorder 108 waits for a signal, e.g., a detection signal, from the object recognition system in step 604. The detection signal may be indicative of the object recognition system 106 detecting an object in the surveillance area 110. If no detection signal is received, the video recorder continues to wait for such signal as in step 604. If a detection signal is received, the video recorder starts to record live video, e.g., from camera 104, for a predetermined time interval to create a recorded video segment in step 608.

Meanwhile, the object recognition system may compare known objects against the detected object to determine if there is any correlation. If the video recorder receives an identification signal from the object recognition system indicative of the object recognition system identifying the object, e.g., sufficiently correlating the detected object with a known object, then the video recorder saves the recorded video segment in step 614. Otherwise, if the object recognition system cannot identify the object, then the video recorder may erase or discard (e.g. not save), the recorded video segment 612. Finally, if a playback of a particular recorded video segment is requested by the PDA in step 616, the video recorder may retrieve and send the requested recorded video segment to the PDA in step 618.

Erasing video data when an object is not identified by the object recognition system results in efficient data storage, but in some cases may not result in sufficient stored information for investigation of a particular incident. The video recorder may, therefore, be configured to continuously store video and to store a time stamp when a match occurs in the object recognition system. When it is desired to retrieve the video associated with the match, the video may be accessed using the stored timestamp as an index into the continuous stream of recorded video data. To facilitate display of an accurate representation of the video on the PDA, the timestamp should be synchronized to the PDA's clock (or vice versa).

There is thus provided a security system having a PDA wirelessly connected to a network to provide a user of the PDA with efficient access and control of various components and systems of the network. The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

1. A security system comprising:
a camera configured to generate a video signal;
an object recognition system coupled to said camera and configured to receive said video signal; and
a portable personal digital assistant (PDA) wirelessly coupled to said object recognition system and said camera.

2. The security system of claim 1, said system further comprising a video recorder for recording said video signal.

3. The security system of claim 2, wherein said video recorder is wirelessly coupled to said PDA.

4. The security system of claim 1, wherein said PDA comprises a video display configured to display said video signal from said camera.

5. The security system of claim 1, wherein said camera is directed to a surveillance area, and wherein said object recognition system comprises a computer configured to provide a detection signal in response to an object entering said surveillance area.

6. The security system of claim 5, said system further comprising a video recorder configured to receive said video signal from said camera and being responsive to said detection signal to record said video signal to create a recorded video segment.

7. The security system of claim 6, wherein object recognition system further comprises a database, said database comprising stored data associated with each of a plurality of identified objects, said computer further configured to compare data representative of said object entering said surveillance area with said stored data.

8. The security system of claim 7, wherein said video recorder is configured to discard said recorded video segment if said data representative of said object entering said surveillance area does not match said stored data associated with at least one of said plurality of identified objects.

9. The security system of claim 7, wherein said video recorder is configured to store said recorded video segment if said data representative of said object entering said surveillance area matches said stored data associated with at least one of said plurality of identified objects.

10. The security system of claim 1, wherein said camera is directed to a surveillance area and wherein said object recognition system is configured to provide an identification signal to said PDA if data representative of an object entering said surveillance area matches stored data associated with at least one of a plurality of identified objects.

11. The security system of claim 10, wherein said PDA is responsive to said identification signal to provide an alarm signal.

12. The system of claim 10, said system further comprising a video recorder, and wherein said object recognition system is configured to provide said identification signal to said video recorder, said video recorder being responsive to said identification signal provide recorded video to said PDA.

13. The system of claim 1, said system further comprising at least one peripheral device coupled to said network for wireless communication with said PDA.

14. The system of claim 13, wherein said peripheral device comprises an access control system.

15. The system of claim 13, wherein said peripheral device comprises a metal detector.

16. The system of claim 13, wherein said peripheral device comprises an alarm.

17. The system of claim 1, said wherein said PDA comprises at least one data collection device.

18. The system of claim 17, wherein said data collection device comprises a barcode scanner.

19. The system of claim 17, wherein said data collection device comprises a digital camera.

20. The system of claim 17, wherein said data collection device comprises a proximity card detector.

21. A method of providing security information, said method comprising:
generating live video of a surveillance area;
communicating said live video via a wireless connection to a portable personal digital assistant (PDA); and
displaying said live video on said PDA.

22. The method of claim 21, further comprising:
detecting entry of an object into said surveillance area; and
providing an indication of said entry of said object into said surveillance area to said PDA.

23. The method of claim 21, said method further comprising:
comparing data representative of an object entering said surveillance area with stored data; and
providing a signal to said PDA in response to said comparing step.

24. The method of claim 21, further comprising:
detecting entry of an object into said surveillance area; and
recording said live video in response to entry of said object into said surveillance area to create a recorded video segment.

25. The method of claim 24, said method further comprising displaying said recorded video segment on said PDA.

26. The method of claim 25, said method further comprising stopping said display of said live video on said PDA.

27. The method of claim 24, said method further comprising comparing data representative of said object with stored data.

28. The method of claim 27, said method further comprising discarding said recorded video segment in response to said comparing step.

29. The method of claim 27, wherein said method further comprising saving said recorded video in response to said comparing step.

30. The method of claim 27, said method further comprising providing data associated with said object to said PDA.

31. The method of claim 30, wherein said data comprises an image file representative of said object.

32. The method of claim 31, wherein said object comprises a human.

33. A method of providing security information, said method comprising:
operating a camera to capture an image of an object;
comparing data representative of said object with stored data; and
providing a signal to a portable digital assistant (PDA) in response to said comparing step.

34. The method of claim 33, wherein said image comprises a video image.

35. The method of claim 33, said method further comprising displaying said image on said PDA.

36. The method of claim 33, wherein said signal comprises an alarm signal.

37. The method of claim 33, further comprising:
detecting entry of said object into a surveillance area; and
providing an indication of said entry of said object into said surveillance area at said PDA.

38. The method of claim 37, further comprising recording said live video in response to said detecting step to create a recorded video segment.

39. The method of claim 38, said method further comprising discarding said recorded video segment in response to said comparing step.

40. The method of claim 38, said method further comprising saving said recorded video in response to said comparing step.

41. The method of claim 33, wherein said signal comprises data associated with said object.

42. The method of claim 41, wherein said data comprises an image file representative of said object.

43. The method of claim 33, wherein said object comprises a human.
